(19) United States
(12) Patent Application Publication
(10) Pub. No.: US 2023/0096585 A1
(43) Pub. Date: Mar. 30, 2023

(54) SYSTEMS AND METHODS FOR UCIe-AIB CHIPLET INTERFACE INTEROPERABILITY

(71) Applicant: Intel Corporation, Santa Clara, CA (US)

(72) Inventors: Yanjing Ke, Union City, CA (US); Yew Fatt Kok, Newark, CA (US)

(21) Appl. No.: 18/075,183

(22) Filed: Dec. 5, 2022

(51) Int. Cl. G06F 13/40

(52) U.S. Cl. CPC G06F 13/4004

(57) ABSTRACT

The present disclosure is directed to improving compatibility between chiplets integrated with disparate chiplet interfaces. To reduce compatibility issues due non-matching bump maps, a dual-mode bump map assignment may be implemented to enable a chiplet to utilize multiple signal number sequence assignments. Additionally, a modularized Advanced Interface Bus (AIB) interface may be implemented to reduce channel mismatch in AIB -UCIe multi-channel interoperability.

### GOVERNMENT LICENSE RIGHTS

This invention was made with government support under Photonics in the Package for Extreme Scalability (PIPES) HR0011-19-3-0003 awarded by the Defense Advanced Research Program Agency (DARPA). The government has certain rights in the invention.

### BACKGROUND

The present disclosure relates generally to integrated circuits, such as those including programmable logic circuitry (e.g., field-programmable gate arrays (FPGA) circuitry). More particularly, the present disclosure relates to maintaining FPGA communication capability during FPGA reconfiguration.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuit devices are found in numerous electronic devices, including computers, handheld devices, automobiles, and more. Some integrated circuits include programmable logic circuitry that can be configured to implement numerous possible systems. The programmable logic circuitry is often referred to as field-programmable gate array (FPGA) circuitry since it can be programmed in the field after manufacturing with diverse functionality.

Heterogeneous integration of multiple chiplets of different designs in a single multichip FPGA package may increase functionality and decrease cost associated with fabricating integrated circuits. However, a lack of standardized connection between chiplets has led to a wide range of proprietary chiplet interconnects, which may result in interface compatibility issues, such as routing and signal performance issues.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit, in accordance with an embodiment of the present disclosure;

FIG. 2 is a block diagram of an example of the integrated circuit of FIG. 1 as a programmable logic device, in accordance with an embodiment of the present disclosure;

FIG. 3 is a diagram of a multichip package (MCP) that may support heterogenous integration of multiple chiplets;

FIG. 4 is a diagram illustrating bump maps corresponding to two chiplets integrated with the Advanced Interconnect Bus (AIB) standard;

FIG. 5 is a is a diagram illustrating bump maps corresponding to two chiplets integrated with the Universal Chiplet Interconnect Express (UCIe) standard;

FIG. 6 is a diagram illustrating bump maps corresponding to two chiplets integrated with incompatible chiplet interface standards;

FIG. 7 is a schematic diagram illustrating a physical layer design of a dual-mode chiplet that may enable compatible interfacing between various chiplet standards, in accordance with an embodiment of the present disclosure;

FIG. 8 illustrates how a dual-mode chiplet may combine the transmit functionalities of an AIB chiplet and a UCIe chiplet, in accordance with an embodiment of the present disclosure;

FIG. 9 illustrates a dual-mode chiplet interfacing with the UCIe chiplet, in accordance with an embodiment of the present disclosure;

FIG. 10 illustrates the dual-mode chiplet interfacing with the AIB chiplet, in accordance with an embodiment of the present disclosure;

FIG. 11 is a diagram illustrating channel mismatch due to differences in channel widths between an AIB chiplet and a set of UCIe chiplets;

FIG. 12 illustrates interoperability between an AIB module having an AIB Auxiliary channel and the UCIe module, according to embodiments of the present disclosure;

FIG. 13 illustrates interoperability between an AIB module having a spare channel and the UCIe module, according to embodiments of the present disclosure;

FIG. 14 illustrates interoperability between a general AIB chiplet, a modularized AIB chiplet, and a UCIe chiplet, in accordance with an embodiment of the present disclosure; and

FIG. 15 is a block diagram of a data processing system that may use a programmable logic device to rapidly respond to data processing requests, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Programmable logic devices are increasingly permeating markets and are increasingly enabling customers to implement circuit designs in a logic fabric (e.g., programmable logic). Certain programmable logic devices, such as those containing field programmable gate array (FPGA) circuitry may use static random-access memory (SRAM) as configuration memory (CRAM), and thus lose their programming when they are powered down and thus are reprogrammed when powered on. A programmable logic device that uses field programmable gate array circuitry may be referred to as an FPGA, though it should be appreciated that other integrated circuits may include such programmable logic circuitry even if they are not necessarily an FPGA by classification. For ease of discussion, integrated circuits that include programmable logic circuitry will be referred to as an FPGA in the text below.

Heterogeneous integration of multiple chiplets of different designs in a single multichip package may increase functionality and decrease cost associated with fabricating integrated circuits. However, a lack of standardized connection between chiplets has led to a wide range of proprietary chiplet interconnects, which may result in interface compatibility issues, such as routing and signal performance issues. Some FPGAs may utilize an Advanced Interconnect Bus (AIB) chiplet interface developed by INTEL®. However, other FPGAs (or other chiplets interfacing on the same FPGA) may utilize a different interface, such as a Universal Chiplet Interconnect Express (UCIe) interface. Certain interfaces, such as the AIB and the UCIe interfaces, are not inherently compatible. Incompatibility between chiplets may result in routing congestion, mismatched routing, routing length that exceeds a maximum routing length specification, routing length mismatch, degraded signal performance, and so on.

Chiplets may include bump maps, or microbump connection architectures that enable various chiplet functionalities, such as sending and receiving data, routing power signals, clock synchronization, and so on. Chiplets with identical or compatible bump maps may operate with high performance due to routing length matching and identical physical signal arrangement. However, chiplets integrated with various interfaces may include different bump map patterns/pitch, which may cause compatibility issues. For example, a chiplet integrated with AIB may be assigned with a signal number sequence in a horizontal orientation, while a chiplet integrated with UCIe may be assigned with a signal number sequence in a vertical orientation. Such a mismatch may cause signal routing congestion, routing length to exceed a maximum specification, length mismatch, and so on that may negatively impact performance of the FPGA.

To mitigate or eliminate bump map mismatch issues, a dual-mode bump map assignment may be implemented that may enable a chiplet to utilize multiple signal number sequence assignments. For example, a chiplet may be programmable to communicate with another chiplet via a signal number sequence in a horizontal orientation or a vertical orientation. In this way, a dual-mode chiplet that is designed to interface with an AIB -integrated chiplet and/or a UCIe-integrated chiplet may experience reduced or minimized compatibility issues.

Another compatibility issue that may arise from interfacing chiplets designed with disparate interfaces is that each interface may utilize groups of channels, the groups varying in both channel width and number of channels. For example, the UCIe interface may support 1 channel per column, 2 channels per column, or 4 channels per column. The channels may each include a width of 388.8 micrometers (μm). The standard MB interface may support 1, 2, 4, 8, 12, 16, 20, and 24 channels per column, and each channel may include a width of 312.48 μm. The differences in group size and width may cause channel mismatch between an AIB-integrated chiplet and a UCIe-integrated chiplet. Such mismatches may cause compatibility issues that may compound as the number of channels per column increases.

To mitigate or eliminate the compatibility issues, a modularized AIB design may be used for AIB-UCIe multi-channel interoperability. An AIB module may include five channels per module. For example, the AIB module may include 4 data channels plus 1 auxiliary (AUX) channel, or 5 data channels while a similarly positioned UCIe module may utilize the 4 data channels. Any number of modules may be used in conjunction. For example, one module (e.g., five channels) may be used, two modules (e.g., 10 channels) may be used, three modules (e.g., 15 channels) may be used, 4 modules (e.g., 20 channels) may be used, five modules (e.g., 25 channels) may be used, and so on. The modularized AIB interface may enable interoperability between general (e.g., non-modularized) AIB -integrated chiplets, UCIe-integrated chiplets, and chiplets integrated with other interfaces, with reduced or minimized channel mismatch, and thus reduced or minimized compatibility issues.

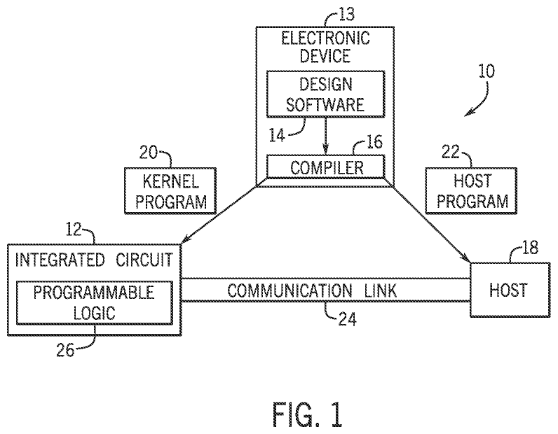

With the foregoing in mind, FIG. 1 illustrates a block diagram of a system 10 that may be used in configuring an integrated circuit. A designer may desire to implement functionality on an integrated circuit 12 (e.g., a programmable logic device such as a field-programmable gate array (FPGA)) or an application-specific integrated circuit (ASIC) that includes programmable logic circuitry). The integrated circuit 12 may include a single integrated circuit, multiple integrated circuits in a package, or multiple integrated circuits in multiple packages communicating remotely (e.g., via wires or traces). In some cases, the designer may specify a high-level program to be implemented, such as an OPENCL® program, which may enable the designer to more efficiently and easily provide programming instructions to configure a set of programmable logic cells for the integrated circuit 12 without specific knowledge of low-level hardware description languages (e.g., Verilog, very high speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit 12.

In a configuration mode of the integrated circuit 12, a designer may use an electronic device 13 (e.g., a computer) to implement high-level designs (e.g., a system user design) using design software 14, such as a version of INTEL® QUARTUS® by INTEL CORPORATION. The electronic device 13 may use the design software 14 and a compiler 16 to convert the high-level program into a lower-level description (e.g., a configuration program, a bitstream). The compiler 16 may provide machine-readable instructions representative of the high-level program to a host 18 and the integrated circuit 12. The host 18 may receive a host program 22, which may be implemented by the kernel programs 20. To implement the host program 22, the host 18 may communicate instructions from the host program 22 to the integrated circuit 12 via a communications link 24, which may be, for example, direct memory access (DMA) communications or peripheral component interconnect express (PCIe) communications. In some embodiments, the kernel programs 20 and the host 18 may enable configuration of programmable logic 26 on the integrated circuit 12. The programmable logic 26 may include circuitry and/or other logic elements and may be configured to implement arithmetic operations, such as addition and multiplication.

The designer may use the design software 14 to generate and/or to specify a low-level program, such as the low-level hardware description languages described above. Further, in some embodiments, the system 10 may be implemented without a separate host program 22. Thus, embodiments described herein are intended to be illustrative and not limiting.

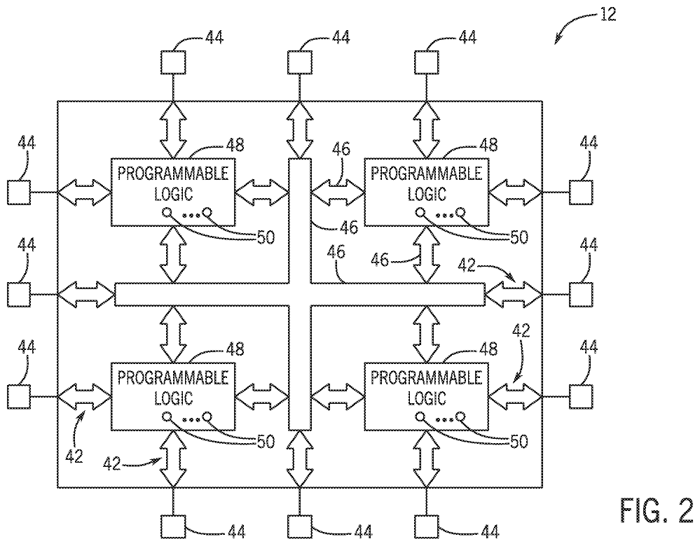

A controller may receive the programs 20 and 22 (bitstreams) and operate to configure the integrated circuit 12 according to the programs 20 and 22 (bitstreams). For example, as depicted in FIG. 2, the integrated circuit 12 may be a FPGA that may be reconfigured according to the programs 20 and 22 (bitstreams) to perform a wide range of tasks and/or functions.

Turning now to a more detailed discussion of the integrated circuit 12, FIG. 2 is a block diagram of an example of the integrated circuit 12 as a programmable logic device, such as a field-programmable gate array (FPGA). Further, it should be understood that the integrated circuit 12 may be any other suitable type of programmable logic device (e.g., an ASIC and/or application-specific standard product). The integrated circuit 12 may have input/output circuitry 42 for driving signals off of the device (e.g., integrated circuit 12) and for receiving signals from other devices via input/output pins 44. Interconnection resources 46, such as global and local vertical and horizontal conductive lines and buses, and/or configuration resources (e.g., hardwired couplings, logical couplings not implemented by user logic), may be used to route signals on integrated circuit 12. Additionally, interconnection resources 46 may include fixed interconnects (conductive lines) and programmable interconnects (i.e., programmable connections between respective fixed interconnects). Programmable logic 26 may include combinational and sequential logic circuitry. For example, programmable logic 26 may include look-up tables, registers, and multiplexers. In various embodiments, the programmable logic 26 may be configured to perform a custom logic function. The programmable interconnects associated with interconnection resources may be considered to be a part of programmable logic 26.

Programmable logic devices, such as the integrated circuit 12, may include programmable elements 50 with the programmable logic 26. For example, as discussed above, a designer (e.g., a customer) may program (e.g., configure) or reprogram (e.g., reconfigure, partially reconfigure) the programmable logic 26 to perform one or more desired functions. By way of example, some programmable logic devices may be programmed or reprogrammed by configuring programmable elements 50 using mask programming arrangements, which is performed during semiconductor manufacturing. Other programmable logic devices are configured after semiconductor fabrication operations have been completed, such as by using electrical programming or laser programming to program programmable elements 50. In general, programmable elements 50 may be based on any suitable programmable technology, such as fuses, antifuses, electrically programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming (i.e., configuration), configuration data is loaded into the memory cells using input/output pins 44 and input/output circuitry 42. In one embodiment, the memory cells may be implemented as random-access-memory (RAM) cells. The use of memory cells based on RAM technology is described herein is intended to be only one example. Further, since these RAM cells are loaded with configuration data during programming, they are sometimes referred to as configuration RAM cells (CRAM). These memory cells may each provide a corresponding static control output signal that controls the state of an associated logic component in programmable logic 26. For instance, in some embodiments, the output signals may be applied to the gates of metal-oxide-semiconductor (MOS) transistors within the programmable logic 26.

I. UCIe-AIB Interface Interoperability Bump Map Design

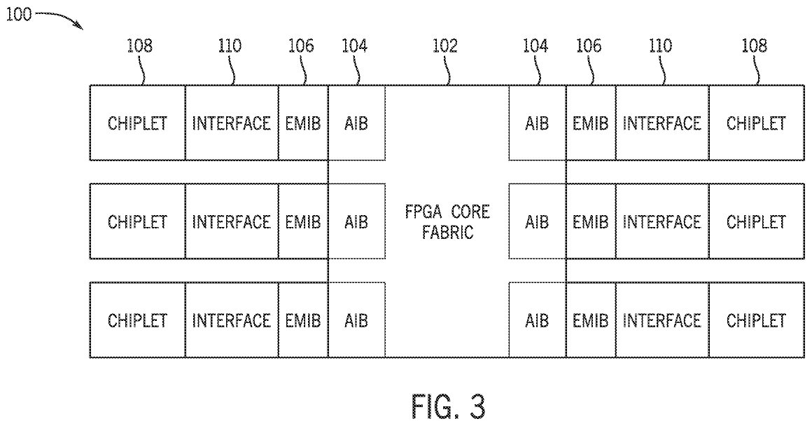

FIG. 3 is a diagram of a multichip package (MCP) 100 that may support heterogenous integration of multiple chiplets. The MCP 100 includes FPGA core fabric 102 (e.g., the programmable logic 48) configured with Advanced Interconnect Bus (AIB) interfaces 104. The FPGA core fabric 102 may interface with a variety of chiplets via Embedded Multi-Die Interconnect Bridge (EMIB) interconnects 106. One or more of the chiplets 108 may, in some cases, be integrated with an interface 110 adhering to the same standard as the FPGA core fabric 102 (e.g., AIB) or another compatible standard. However, in other cases, one or more of the chiplets 108 may be integrated with a standard that is not natively compatible with the standard of the FPGA core fabric 102. For example, the chiplets 108 may be integrated with interfaces 110 that adhere to the Universal Chiplet Interconnect Express (UCIe) standard, which is not natively compatible with AIB. Communication between the chiplets 108 or the FPGA core fabric 102 and the chiplets 108 with incompatible interfaces 110 may result in routing and signal performance issues, diminishing performance of the MCP 100.

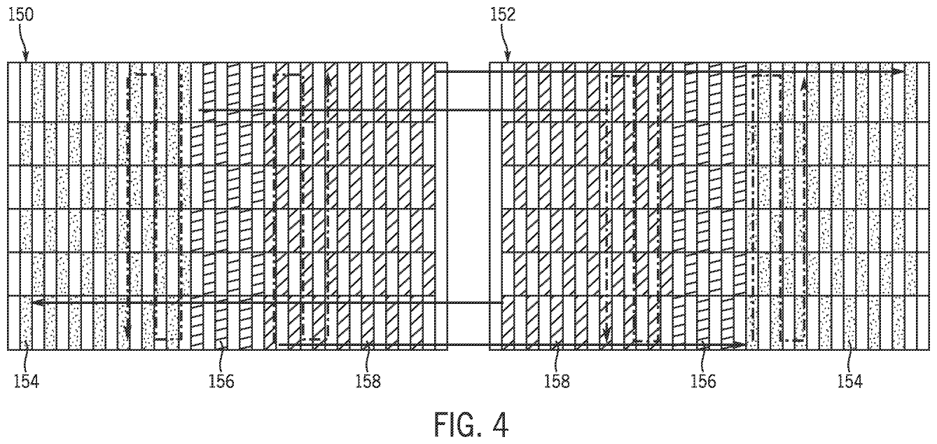

FIG. 4 is a diagram illustrating bump maps corresponding to two chiplets 150 and 152 integrated with the AIB standard. The AIB chiplets 150 and 152 may include bumps 154, 156, and 158. The bumps 154 may receive data. The bumps 156 may send and/or receive clock signals, ready signals, loading signals, and so on, and the bumps 158 may send data. The bumps 152, 154, and 158 of the AIB chiplets 150 and 152 integrated with the AIB standard are assigned with a signal sequence in a generally vertical direction, as indicated by the dashed arrow. As the bump maps of each of the AIB chiplets 150 and 152 correspond to interfaces each integrated with the AIB standard, the standardized connection may be compatible and consequently provide few or no communication or routing issues. For example, data sent by the bumps 158 of the AIB chiplet 150 may be received by the appropriate corresponding bumps 154 of the AIB chiplet 152 with few or no issues due to minimal or no misalignment between the bump maps of the AIB chiplets 150 and 152. While AIB interfaces are discussed with respect to chiplets, it should be noted that the same principle may be applied to a chiplet and the FPGA core logic 102 integrated with an AIB interface.

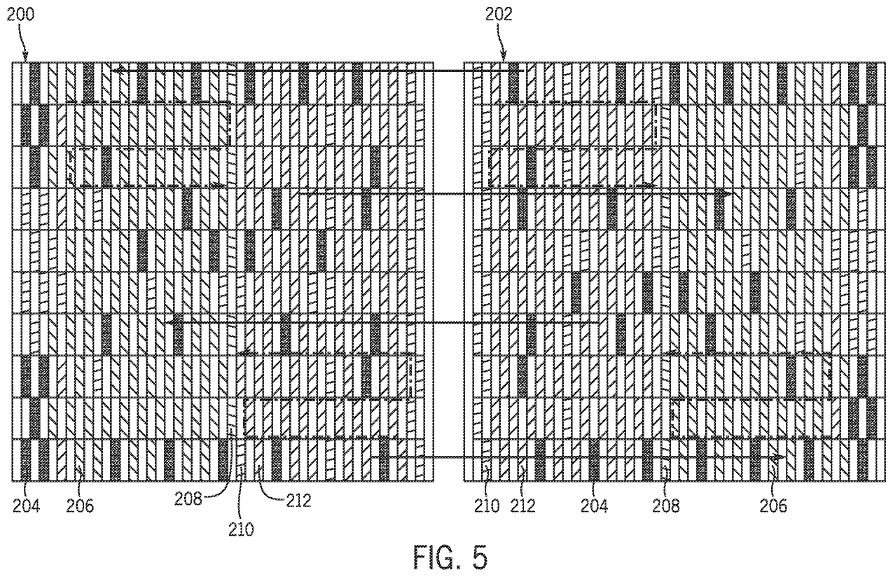

FIG. 5 is a diagram illustrating bump maps corresponding to two chiplets 200 and 202 interconnected using the UCIe standard. The UCIe chiplets 200 and 202 may include bumps 204, 206, 208, 210, and 212. The bumps 204 may operate as a ground. The bumps 208 and 210 may provide power to the chiplets. The bumps 206 may receive data, and the bumps 212 may send data. The bumps 204, 206, 208, 210, and 212 the UCIe chiplets 200 and 202 are assigned with a signal sequence oriented generally in a horizontal direction (or cross-wise to the direction used by AIB interfaces), as indicated by the dashed arrows. Similar to the AIB chiplets 150 and 152 in FIG. 4, the UCIe chiplets 200 and 202 are each integrated with the same standard (this time UCIe), and as such, the standardized connection may result in few or no issues due to misalignment between the bump maps of the UCIe chiplets 200 and 202. For example, data sent by the bumps 212 of the UCIe chiplet 200 may be received by the appropriate corresponding bumps 206 of the UCIe chiplet 202 with few or no issues due to minimal or no misalignment between the chiplets 200 and 202.

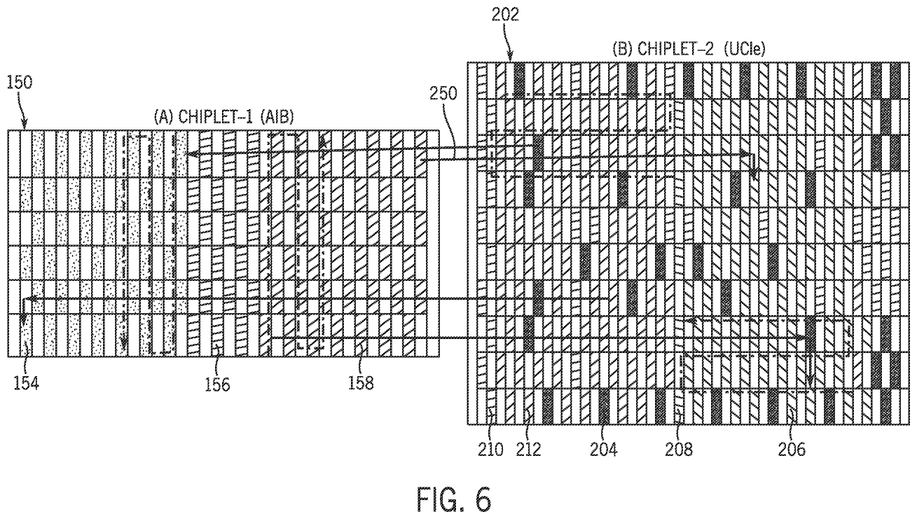

FIG. 6 is a diagram illustrating bump maps corresponding to two chiplets integrated with incompatible chiplet interface standards. As previously discussed with respect to FIGS. 4 and 5, chiplets with identical or compatible bump maps (e.g., the chiplets 150/152 and the chiplets 200/202) may operate with high performance due to routing length matching and identical physical signal arrangement. However, chiplets integrated with different interfaces may include different and sometimes incompatible bump maps, which may cause compatibility issues. Such compatibility issues may stem from differences in the physical layouts of the chiplets and their interfaces. For example, AIB -integrated chiplets (e.g., 150 and 152) and UCIe-integrated chiplets (e.g., 200 and 202) may have different numbers of pins, different numbers of logic slices, logic slices with different functionalities, and so on.

The AIB chiplet 150 of FIG. 6 is assigned with a signal number sequence in a horizontal orientation according to the AIB standard. Conversely, the UCIe chiplet 202 is assigned with a signal number sequence in a vertical orientation according to the UCIe standard. Such a mismatch may cause signal routing congestion, routing lengths to exceed a maximum specification, length mismatch, and other compatibility issues that may negatively impact performance of an FPGA or multi-chip package. For example, an arrow 250 indicates a data transmit bump 158 of the AIB chiplet 150 attempting to transmit data to a receive data bump 206 of the UCIe chiplet 202. As may be observed, due to misalignment between the chiplets 150 and 202, the data may not reach the intended receive data bump 206 and/or may be significantly different (e.g., shorter) than other interconnections used in the heterogenous interface. Such mismatch and misalignment may negatively impact the performance of the MCP 100.

To mitigate or eliminate bump mismatches, a dual-mode chiplet may be implemented. The dual-mode chiplet may be integrated with a dual-mode bump map assignment that may enable the dual-mode chiplet to utilize multiple signal number sequence assignments according to multiple different interface specifications. For example, a chiplet may be programmable to communicate with another chiplet via a signal number sequence in a horizontal orientation while in a first mode or a vertical orientation in a second mode (e.g., connected to a different chiplet). In this way, a dual-mode chiplet is capable to interface with an AIB -integrated chiplet and/or a UCIe-integrated chiplet with reduced or minimized compatibility issues.

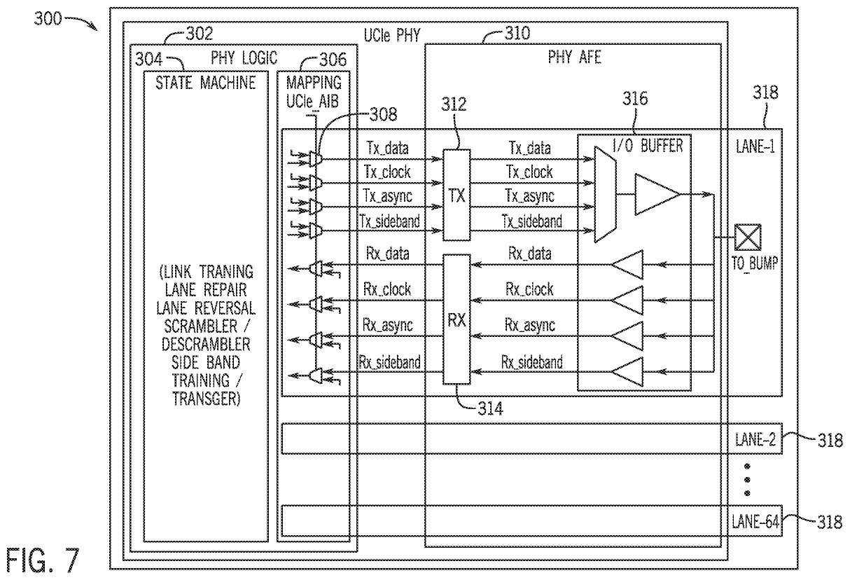

FIG. 7 is a schematic diagram illustrating a physical layer design of a dual-mode chiplet 300 that may enable compatible interfacing between various chiplets adhering to different standards, according to embodiments of the present disclosure. The dual-mode chiplet 300 may be configured to transmit or receive synchronous data/clock signals, sideband data/clock signals, asynchronous data, and so on. The dual-mode chiplet 300 includes physical logic 302 including a state machine 304 and mapping circuitry 306. The state machine may support link training, lane repair, lane reversal, scrambling and descrambling, and sideband training and/or transfer, in addition to other functionalities. The mapping circuitry 306 includes multiplexers 308. A subset of the multiplexers 308 may output data to transmit circuitry 312 of a physical analog front end (AFE) 310 based on a selected mode (e.g., features enabled or locations suitable for UCIe or AIB). The transmit circuitry 312 may output the data to an input/output (IO) buffers 316. The I0 buffer 316 may transmit data to an I0 lane 318 when the I0 lane 318 is used to output data from the FPGA. In a receive state, the I0 lane 318 receives data and transmits it to receive circuitry 314 via the I0 buffers 316. The receive circuitry 314 in turn transmits the data to a subset of the multiplexers 308. The multiplexers 308 used in the receive direction are used to select data from a location based at least in part on the set mode (e.g., UCIe or AIB). In this manner, the dual-mode chiplet 300 may include an appropriate number of 10 lanes (e.g., 8 lanes, 16 lanes, 32 lanes, 64 lanes, 128 lanes) that may each include their own mapping circuitry 306 including the multiplexers 308, the transmit circuitry 312, receive circuitry 314, and I0 buffers 316.

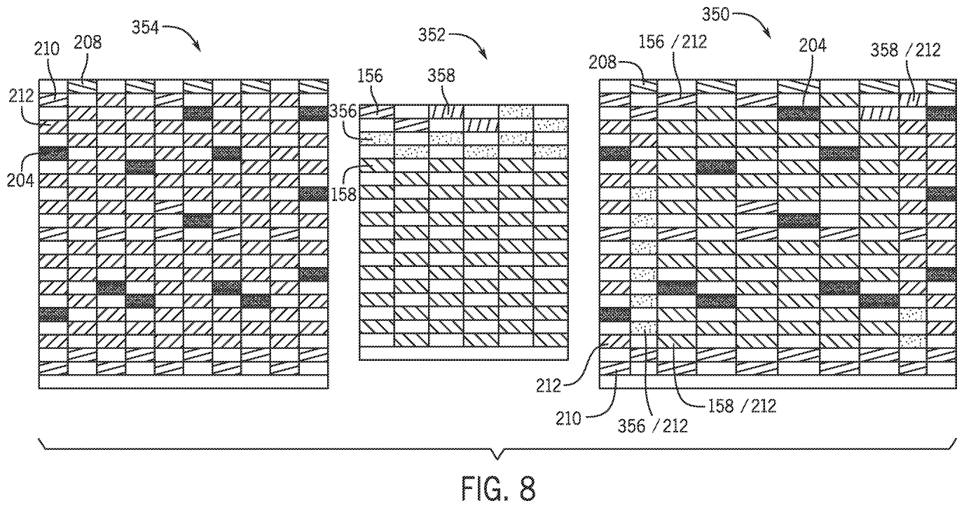

FIG. 8 illustrates how a dual-mode chiplet 350 may combine certain functionalities of an AIB chiplet 352 and a UCIe chiplet 354, according to an embodiment of the present disclosure. As may be appreciated, the bump map corresponding to the dual-mode chiplet 350 combines the bumps 204, 208, 210, and 212 of the UCIe chiplet 354 and the bumps 156, 158, 356, and 358 of the AIB chiplet 352. While not shown in FIG. 8, the AIB chiplet 352 may, in some embodiments, include the bumps 154 configured to receive data as illustrated with respect to the AIB chiplets 150 and 152 of FIG. 4. Additionally, while not shown in FIG. 8, the UCIe chiplet 354 may, in some embodiments, include the bumps 206 configured to receive data as illustrated with respect to the UCIe chiplets 200 and 202 of FIG. 5. With respect to the AIB chiplet 352, the bumps 356 may include clock, data, ready, and load signals, and the bumps 358 may include spare bumps that may be mapped to one or more functionalities in the dual-mode chiplet 350.

As may be observed from the dual-mode chiplet 350, the bumps 208 and 210 may be integrated to provide power to the dual-mode chiplet 350 and chiplets with which the dual-mode chiplet 350 interfaces. The bumps 204 may be integrated to provide ground connections. The bumps 212 may be integrated to transmit data for single-mode (e.g., UCIE), and the bumps 156, 158, 356, and 358, may be reused/reconfigured to transmit data from the dual-mode chiplet 350.

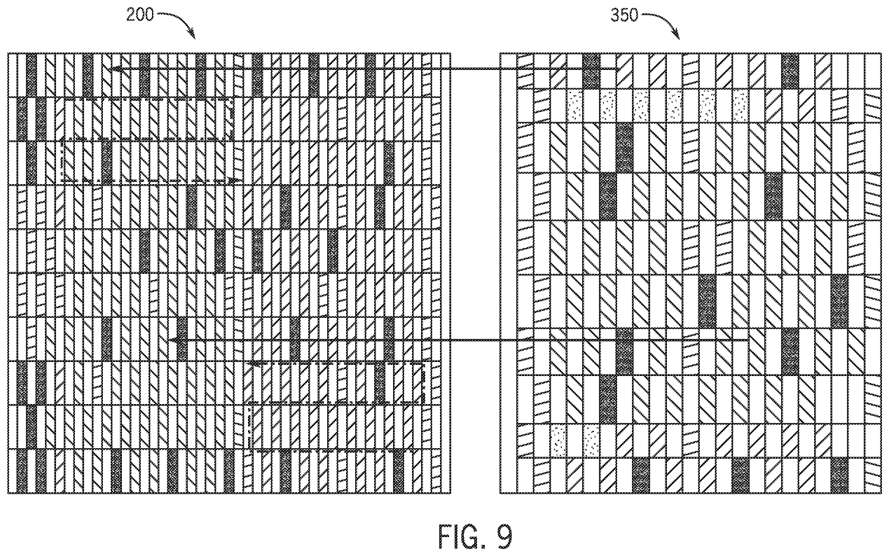

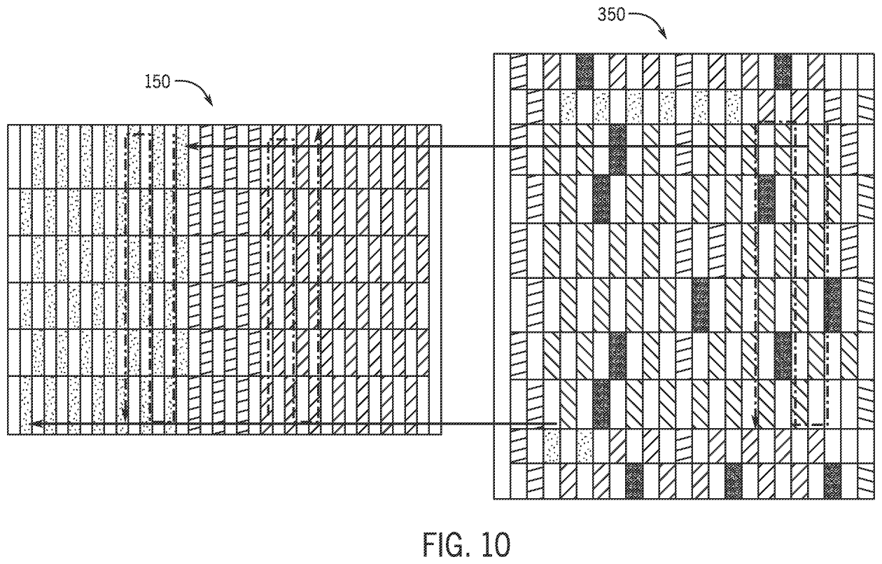

FIG. 9 illustrates a dual-mode chiplet 350 in UCIe mode interfacing with the UCIe chiplet 200 according to embodiments of the present disclosure. To interface with the UCIe chiplet 200, the dual-mode chiplet 350 may operate in a UCIe bump mode. In the UCIe bump mode, the dual-mode chiplet 350 may be configured such that the bump assignment is mapped in a horizontal direction using the mapping circuitry 306 matching the horizontal orientation of the bump assignments of the chiplet 200. FIG. 10 illustrates the dual-mode chiplet 350 interfacing with the AIB chiplet 150, according to embodiments of the present disclosure. To interface with the AIB chiplet 150, the dual-mode chiplet 350 may operate in an AIB bump mode. In the AIB bump mode, the dual-mode chiplet 350 may be configured such that the bump assignment is mapped in a vertical direction using the mapping circuitry 306 matching the vertical orientation of the bump assignments of the AIB chiplet 150. When in the AIB bump mode, the signal routings between the dual-mode chiplet 350 and the AIB chiplet 150 may simulate two AIB interface routings.

In this manner, the dual-mode chiplet 350 may mitigate or eliminate bump map mismatch between chiplets in a multi-chip package (e.g., 100). While the dual-mode chiplet 350 is discussed as being configurable to interface with UCIe chiplets and AIB chiplets, it should be noted that this is merely for the purpose of illustrating an example, and the dual-mode chiplet 350 may be configurable to interface with chiplets that are integrated with any appropriate chiplet interface standard and may interface with FPGA core logic 102 as well as with chiplets.

II. Modularized AIB Design for AIB to UCIe Multi-Channel Interoperability

As previously discussed, another compatibility issue that may arise from interfacing chiplets designed with disparate interfaces is that each interface may utilize groups of channels, the groups varying in both channel width and number of channels. For example, a UCIe interface may support 1 channel per column, 2 channels per column, or 4 channels per column. The channels may each include a width of 388.8 micrometers (μm). The standard MB interface may support 1, 2, 4, 8, 12, 16, 20, and 24 channels per column, and each channel may include a width of 312.48 μm. The differences in group size and width may cause channel mismatch between an AIB-integrated chiplet and a UCIe-integrated chiplet. Such mismatches may cause compatibility issues that may compound as the number of channels per column increases.

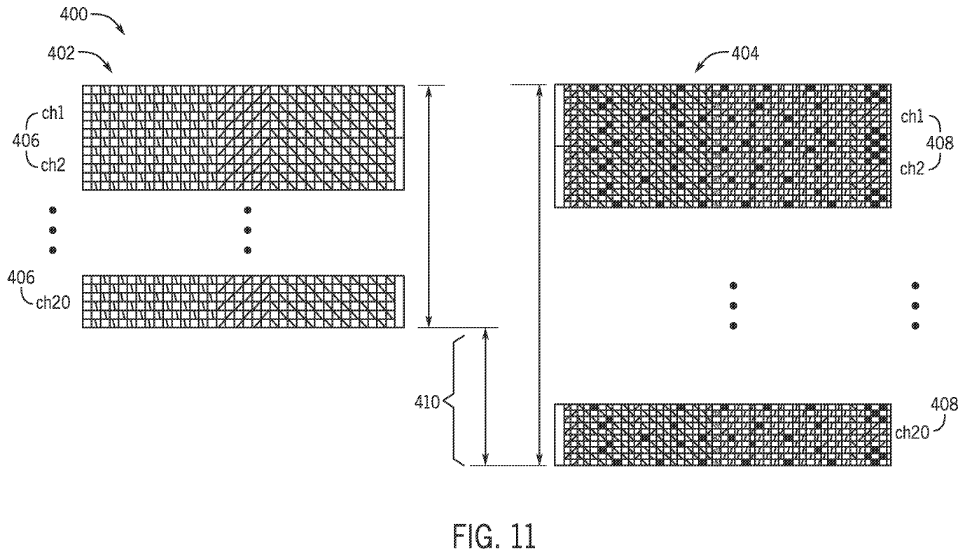

FIG. 11 is a diagram 400 illustrating channel mismatch due to differences in channel widths between an AIB chiplet 402 and a set of UCIe chiplets. The AIB chiplet 402 may support 20 AIB data channels 406 per column and the set of UCIe chiplets may include 5 UCIe modules 404 supporting 4 UCIe data channels 408 per column each. The width of each of the AIB data channels 406 may be 312.48 μm and the width of each of the UCIe data channels 408 may be 388.8 μm. As the number of channels in a column grows, the mismatch between corresponding channels of the respective chiplets may increase accordingly. For example, the mismatch between channel 5 of the corresponding chiplets may have a mismatch greater than at channel 1; the mismatch between channel 10 of the corresponding chiplets may have a mismatch greater than at channel 5, and the mismatch between channel 15 of the corresponding chiplets may have a mismatch greater than channel 10. At the corresponding channel 20, the mismatch 410 may be greater than 1500 μm.

To mitigate or eliminate the compatibility issues due to such channel mismatches, a modularized AIB design may be implemented in the datalink layer to enable AIB-UCIe multi-channel interoperability. An AIB module may include five channels per module. For example, the AIB module may include 4 data channels plus 1 auxiliary (AUX) channel, or 5 data channels while a UCIe module includes 4 channels to accommodate the wider channels while matching the width of the AIB module more closely. Any number of modules may be used in conjunction. For example, one module (e.g., five channels) may be used, two modules (e.g., 10 channels) may be used, three modules (e.g., 15 channels) may be used, 4 modules (e.g., 20 channels) may be used, five modules (e.g., 25 channels) may be used, and so on. The modularized AIB interface may enable interoperability between general (e.g., non-modularized) AIB -integrated chiplets, UCIe-integrated chiplets, and chiplets integrated with other interfaces, with reduced or minimized channel mismatch, and thus reduced or minimized compatibility issues.

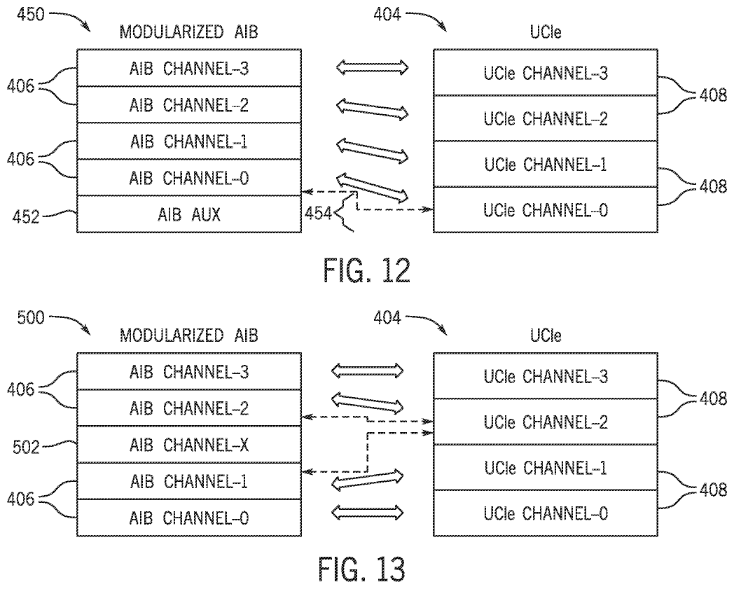

FIG. 12 illustrates interoperability between an AIB module 450 having an AIB Auxiliary channel 452 and a UCIe module 404, according to embodiments of the present disclosure. As may be observed, the AIB module 450 includes four AIB data channels 406 and one auxiliary channel 452. The AIB data channels 406 may interface one-to-one with the four UCIe data channels 408. In embodiments where multiple AIB modules 450 interface with multiple UCIe modules 404, the buffer provided by the auxiliary channel 452 may provide a width offset that may serve to reduce the width mismatch with each consecutive module.

FIG. 13 illustrates interoperability between an AIB module 500 having a spare channel 502 and the UCIe module 404, according to embodiments of the present disclosure. The AIB data channels 406 may interface one-to-one with the UCIe data channels 408 and the spare channel 502 may not be used for data transfer. The spare channel 502 may be used as a width buffer to reduce misalignment between the AIB data channels 406 and the UCIe data channels 408 when used with an AIB-to-UCIe interface. Due to the use of the spare channel 502, the width mismatch between corresponding data channels (e.g., between the AIB channel 2 and the UCIe channel 2 and/or the AIB channel 1 and the UCIe channel 1) may be reduced (e.g., approximately 150 μm). While the spare channel 502 is shown as the center channel of the of the AIB module 500, it should be noted that the spare channel 502 may designated at to any channel in the AIB module 500. Further, it should be noted that the spare channel 502 may be configured to transfer data when coupled to an AIB interface. As will be illustrated below, an AIB module may include both auxiliary channels 452 and spare channels 502.

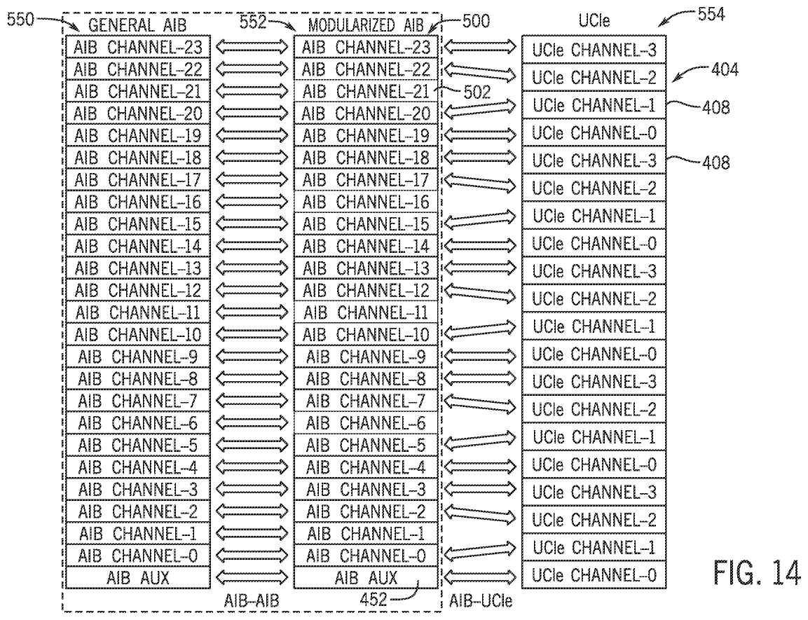

FIG. 14 illustrates interoperability between a general AIB chiplet 550, a modularized AIB chiplet 552, and/or a UCIe chiplet 554, according to embodiments of the present disclosure. As may be appreciated, the modularized AIB chiplet 552 may interface with the general AIB chiplet 550 with little to no mismatch, as the general AIB chiplet 550 and the modularized AIB chiplet 552 have the same number of channels with identical/similar channel widths. Additionally or alternatively, the modularized AIB chiplet 552 may interface with the UCIe chiplet 554 via AIB modules 500 utilizing the spare channels 502, AIB modules 450 utilizing auxiliary channels 452, or both. Interfacing with the UCIe chiplet 554 via the modularized AIB 552 may reduce the channel width mismatch by one-fifth or more when compared to interfacing with the general AIB chiplet 550. For example, the mismatch between the general AIB chiplet 550 and the UCIe chiplet 554 at channel 20 may be relatively wide (e.g., approximately 1526μm), while the mismatch between the modularized AIB chiplet 552 and the UCIe chiplet 554 at channel 20 may be relatively small (e.g., approximately 270μm). In this manner, using the modularized AIB chiplet 552 may reduce channel mismatch, and as a result may reduce signal routing congestion, may reduce improper routing, and may generally enhance performance of the FPGA.

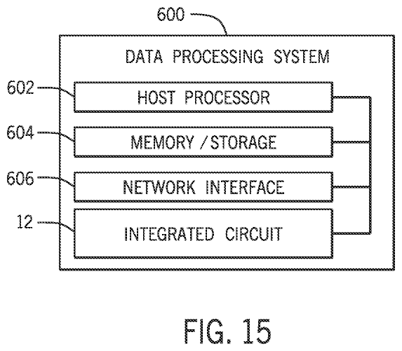

With the foregoing in mind, the integrated circuit 12 may be a data processing system or may be a component of a data processing system that may benefit from application of one of the many clock frequency ramping techniques described herein. For example, the integrated circuit 12 may be a component of a data processing system 600, shown in FIG. 15. The data processing system 600 includes a host processor 602, memory and/or storage circuitry 604, and a network interface 606. The data processing system 600 may include more or fewer components (e.g., electronic display, user interface structures, application specific integrated circuits (ASICs)). The host processor 602 may include any suitable processor, such as an Intel® Xeon® processor or a reduced-instruction processor (e.g., a reduced instruction set computer (RISC), an Advanced RISC Machine (ARM) processor) that may manage a data processing request for the data processing system 600 (e.g., to perform machine learning, video processing, voice recognition, image recognition, data compression, database search ranking, bioinformatics, network security pattern identification, spatial navigation, or the like). The memory and/or storage circuitry 604 may include random access memory (RAM), read-only memory (ROM), one or more hard drives, flash memory, or the like. The memory and/or storage circuitry 604 may be considered external memory to the integrated circuit 12 and may hold data to be processed by the data processing system 600. In some cases, the memory and/or storage circuitry 604 may also store configuration programs (e.g., bitstreams) for programming the integrated circuit 12. The network interface 606 may permit the data processing system 600 to communicate with other electronic devices. The data processing system 600 may include several different packages or may be contained within a single package on a single package substrate.

In one example, the data processing system 600 may be part of a data center that processes a variety of different requests. For instance, the data processing system 600 may receive a data processing request via the network interface 606 to perform machine learning, video processing, voice recognition, image recognition, data compression, database search ranking, bioinformatics, network security pattern identification, spatial navigation, or some other specialized task. The host processor 602 may cause the programmable logic fabric of the integrated circuit 12 to be programmed with a particular accelerator related to requested task. For instance, the host processor 602 may instruct that configuration data (bitstream) stored on the memory/storage circuitry 604 or cached in sector-aligned memory of the integrated circuit 12 to be programmed into the programmable logic fabric (e.g., programmable logic 26) of the integrated circuit 12. The configuration data (bitstream) may represent a circuit design for a particular accelerator function relevant to the requested task. Due to the high density of the programmable logic fabric, the proximity of the substantial amount of sector-aligned memory to the programmable logic fabric, or other features of the integrated circuit 12 that are described here, the integrated circuit 12 may rapidly assist the data processing system 600 in performing the requested task.

The methods and devices of this disclosure may be incorporated into any suitable circuit. For example, the methods and devices may be incorporated into numerous types of devices such as microprocessors or other integrated circuits. Exemplary integrated circuits include programmable array logic (PAL), programmable logic arrays (PLAs), field programmable logic arrays (FPLAs), electrically programmable logic devices (EPLDs), electrically erasable programmable logic devices (EEPLDs), logic cell arrays (LCAs), field programmable gate arrays (FPGAs), application specific standard products (ASSPs), application specific integrated circuits (ASICs), and microprocessors, just to name a few.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . “, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. An electronic device, comprising:

a field-programmable gate array (FPGA) configured to interface with a chiplet, the FPGA comprising an interface configurable to interface with a programmable fabric of the FPGA based on entering a first mode, wherein the first mode comprises configuring a bump assignment orientation in a first direction, or configurable to interface with the chiplet by entering a second mode, wherein the second mode comprises configuring a bump assignment orientation in a second direction.

EXAMPLE EMBODIMENT 2. The electronic device of example embodiment 1, wherein the first mode causes the bump assignment to be assigned according to an Advanced Interconnect Bus (AIB) standard.

EXAMPLE EMBODIMENT 3. The electronic device of example embodiment 1, wherein the second mode causes the bump assignment to be assigned according to a Universal Chiplet Interconnect Express (UCIe) standard.

EXAMPLE EMBODIMENT 4. The electronic device of example embodiment 1, wherein the first direction comprises a horizontal direction.

EXAMPLE EMBODIMENT 5. The electronic device of example embodiment 1, wherein the second direction comprises a vertical direction.

EXAMPLE EMBODIMENT 6. The electronic device of example embodiment 1, wherein the interface comprises:

a first set of bumps that are configured to send and/or receive clock signals when the interface is operating in the first mode and are configured to transmit or receive data when the interface is operating in the second mode;

a second set of bumps that are configured to send and/or receive ready signals and loading signals when the interface is operating in the first mode and are configured to transmit or receive data when the interface is operating in the second mode; and

a third set of bumps that are configured to function as spare bumps when the interface is operating in the first mode and are configured to transmit or receive data when the interface is operating in the second mode.

EXAMPLE EMBODIMENT 7. The electronic device of example embodiment 1, wherein the interface comprises a set of bumps that are configurable to send and/or receive data according to an Advanced Interconnect Bus (AIB) standard in the first mode and configurable to send and/or receive data according to a Universal Chiplet Interconnect Express (UCIe) standard in the second mode.

EXAMPLE EMBODIMENT 8. A system, comprising:

a programmable logic device, comprising:

a plurality of interfaces, each configurable to interface with a respective chiplet using one of a plurality of interface types based on a plurality of modes, wherein the plurality of interfaces comprises a first interface and a second interface; and

a first interface configurable to communicatively couple the programmable logic device to a first chiplet via the first interface using a first mode of the plurality of modes, wherein the first mode corresponds to a first microbump assignment configuration; a second interface configurable to communicatively couple the programmable logic device to a second chiplet via the second interface using a second mode of the plurality of modes, wherein the second mode corresponds to a second microbump assignment configuration.

EXAMPLE EMBODIMENT 9. The system of example embodiment 8, wherein the first microbump assignment configuration comprises a plurality of microbumps oriented vertically.

EXAMPLE EMBODIMENT I0. The system of example embodiment 8, wherein the second microbump assignment configuration comprises a plurality of microbumps oriented horizontally.

EXAMPLE EMBODIMENT 11. The system of example embodiment 8, wherein the programmable logic device comprises a first set of microbumps that are configured to send and/or receive clock signals when the first interface is operating in the first mode and are configured to transmit or receive data when the second interface is operating in the second mode.

EXAMPLE EMBODIMENT 12. The system of example embodiment 8, wherein the programmable logic device comprises a set of microbumps that are configured to send and/or receive ready signals and loading signals when the first interface is operating in the first mode and are configured to transmit or receive data when the second interface is operating in the second mode.

EXAMPLE EMBODIMENT 13. The system of example embodiment 8, wherein programmable logic device comprises a set of microbumps that are configured to function as spare bumps when the first interface is operating in the first mode and are configured to transmit or receive data when the second interface is operating in the second mode.

EXAMPLE EMBODIMENT 14. An integrated circuit, comprising:

programmable fabric; and

mapping circuitry configured to enable a single interface of the programmable fabric to interface with a first interface type in a first mode based on a first microbump assignment of a plurality of microbumps and enable the programmable fabric to interface with a second interface type in a second mode based on a second microbump assignment of the plurality of microbumps.

EXAMPLE EMBODIMENT 15. The integrated circuit of example embodiment 14, comprising an analog front end (AFE), the AFE comprising:

a plurality of input/output (IO) buffers;

transmit circuitry configured to transmit data to a first I0 buffer of the plurality of I0 buffers; and

receive circuitry configured to receive data from a second I0 buffer of the plurality of I0 buffers.

EXAMPLE EMBODIMENT 16. The integrated circuit of example embodiment 15, wherein the mapping circuitry comprises a plurality of multiplexers that comprises:

a first subset of the plurality of multiplexers to output data to the transmit circuitry based on a selected mode; and

a second subset of the plurality of multiplexers to select data received from the receive circuitry from a location based at least in part on the selected mode.

EXAMPLE EMBODIMENT 17. The integrated circuit of example embodiment 14, wherein the first mode comprises an Advanced Interface Bus (AIB) mode and, in the AIB mode, the mapping circuitry maps the plurality of microbumps in a vertical direction.

EXAMPLE EMBODIMENT 18. The integrated circuit of example embodiment 14, wherein the second mode comprises a Universal Chiplet Interconnect Express (UCIe) mode and, in the UCIe mode, the mapping circuitry maps the plurality of microbumps in a horizontal direction.

EXAMPLE EMBODIMENT 19. The integrated circuit of example embodiment 14, comprising a state machine, the state machine configured to support link training, lane repair, lane reversal, scrambling, descrambling, sideband training, sideband transfer, or any combination thereof.

EXAMPLE EMBODIMENT 20. The integrated circuit of example embodiment 14, wherein one or more microbumps of a plurality of microbumps are configured to send and/or receive clock signals, receive data, receive ready signals, loading signals, or any combination thereof based on a selected mode.

What is claimed is:

1. An electronic device, comprising:
a field-programmable gate array (FPGA) configured to interface with a chiplet, the FPGA comprising an interface configurable to interface with a programmable fabric of the FPGA based on entering a first mode, wherein the first mode comprises configuring a bump assignment orientation in a first direction, or configurable to interface with the chiplet by entering a second mode, wherein the second mode comprises configuring a bump assignment orientation in a second direction.

2. The electronic device of claim 1, wherein the first mode causes the bump assignment to be assigned according to an Advanced Interconnect Bus (AIB) standard.

3. The electronic device of claim 1, wherein the second mode causes the bump assignment to be assigned according to a Universal Chiplet Interconnect Express (UCIe) standard.

4. The electronic device of claim 1, wherein the first direction comprises a horizontal direction.

5. The electronic device of claim 1, wherein the second direction comprises a vertical direction.

6. The electronic device of claim 1, wherein the interface comprises:
a first set of bumps that are configured to send and/or receive clock signals when the interface is operating in the first mode and are configured to transmit or receive data when the interface is operating in the second mode;
a second set of bumps that are configured to send and/or receive ready signals and loading signals when the interface is operating in the first mode and are configured to transmit or receive data when the interface is operating in the second mode; and
a third set of bumps that are configured to function as spare bumps when the interface is operating in the first mode and are configured to transmit or receive data when the interface is operating in the second mode.

7. The electronic device of claim 1, wherein the interface comprises:
a set of bumps that are configurable to send and/or receive data according to an Advanced Interconnect Bus (AIB) standard in the first mode and configurable to send and/or receive data according to a Universal Chiplet Interconnect Express (UCIe) standard in the second mode.

8. A system, comprising:
a programmable logic device, comprising:
a programmable fabric core; and
a plurality of interfaces, each configurable to interface with a respective chiplet using one of a plurality of interface types based on a plurality of modes, wherein the plurality of interfaces comprises a first interface and a second interface, wherein the first interface is configurable to communicatively couple the programmable logic device to a first chiplet via the first interface using a first mode of the plurality of modes, wherein the first mode corresponds to a first microbump assignment configuration; a second interface configurable to communicatively couple the programmable logic device to a second chiplet via the second interface using a second mode of the plurality of modes, wherein the second mode corresponds to a second microbump assignment configuration.

9. The system of claim 8, wherein the first microbump assignment configuration comprises a plurality of microbumps oriented vertically.

10. The system of claim 8, wherein the second microbump assignment configuration comprises a plurality of microbumps oriented horizontally.

11. The system of claim 8, wherein the programmable logic device comprises a set of microbumps that are configured to send and/or receive clock signals when the first interface is operating in the first mode and are configured to transmit or receive data when the second interface is operating in the second mode.

12. The system of claim 8, wherein the programmable logic device comprises a set of microbumps that are configured to send and/or receive ready signals and loading signals when the first interface is operating in the first mode and are configured to transmit or receive data when the second interface is operating in the second mode.

13. The system of claim 8, wherein programmable logic device comprises a set of microbumps that are configured to function as spare bumps when the first interface is operating in the first mode and are configured to transmit or receive data when the second interface is operating in the second mode.

14. An integrated circuit, comprising:
programmable fabric; and
mapping circuitry configured to enable a single interface of the programmable fabric to interface with a first interface type in a first mode based on a first microbump assignment of a plurality of microbumps and enable the programmable fabric to interface with a second interface type in a second mode based on a second microbump assignment of the plurality of microbumps.

15. The integrated circuit of claim 14, comprising an analog front end (AFE), the AFE comprising:
a plurality of input/output (TO) buffers;
transmit circuitry configured to transmit data to a first IO buffer of the plurality of IO buffers; and
receive circuitry configured to receive data from a second IO buffer of the plurality of IO buffers.

16. The integrated circuit of claim 15, wherein the mapping circuitry comprises a plurality of multiplexers that comprises:
a first subset of the plurality of multiplexers to output data to the transmit circuitry based on a selected mode; and
a second subset of the plurality of multiplexers to select data received from the receive circuitry from a location based at least in part on the selected mode.

17. The integrated circuit of claim 14, wherein the first mode comprises an Advanced Interface Bus (AIB) mode and, in the AIB mode, the mapping circuitry maps the plurality of microbumps in a vertical direction.

18. The integrated circuit of claim 14, wherein the second mode comprises a Universal Chiplet Interconnect Express (UCIe) mode and, in the UCIe mode, the mapping circuitry maps the plurality of microbumps in a horizontal direction.

19. The integrated circuit of claim 14, comprising a state machine, the state machine configured to support link training, lane repair, lane reversal, scrambling, descrambling, sideband training, sideband transfer, or any combination thereof.

20. The integrated circuit of claim 14, wherein one or more microbumps of a plurality of microbumps are configured to send and/or receive clock signals, receive data, receive ready signals, loading signals, or any combination thereof based on a selected mode.
